(19) United States
(12) Patent Application Publication
(10) Pub. No.: US 2022/0087218 A1
(43) Pub. Date: Mar. 24, 2022

(54) ACCESSORY FOR BREEDING ANIMALS WHICH IS DESIGNED TO BE ATTACHED TO A STRUCTURE TO BE COVERED AND PROTECTED

(71) Applicant: GROUP ELASTOTECK, Nort Sur Erdre (FR)

(72) Inventor: Jean-Vincent BIORET, Petit Mars (FR)

(21) Appl. No.: 17/428,750

(22) PCT Filed: Feb. 5, 2020
(86) PCT No.: PCT/FR2020/050198

§ 371 Date: Aug. 5, 2021

(30) Foreign Application Priority Data
Feb. 7, 2019 (FR) 1901236

(51) Int. Cl. A01K 13/00

(52) U.S. Cl. CPC A01K 13/004

(57) ABSTRACT

Disclosed is an accessory for livestock farm, in particular cattle, horses or pigs, intended to be fastened to a structure to be covered and protected. The accessory consists of a plate made of an elastic material, preferably obtained by moulding. This accessory includes: —at least one central strip including a front face and a rear face, the front face being provided with several protruding elements adapted for animal brushing; and —at least two lateral and/or transverse strips, adapted to a receive unit for their securing to the structure.

### CROSS-REFERENCE TO RELATED APPLICATIONS

This application is the U.S. national phase of International Application No. PCT/FR2020/050198 filed Feb. 5, 2020 which designated the U.S. and claims priority to French Application No. 1901236 filed Feb. 7, 2019, the entire contents of each of which are hereby incorporated by reference.

### BACKGROUND OF THE INVENTION

### Field of the Invention

The present invention relates to the technical field of livestock farming, in particular cattle, horses or pigs.

More particularly, it relates to the accessories for livestock farms, intended to be fastened to a structure to be covered and protected.

### Description of the Related Art

Livestock farming requires an environment designed in such a way as to allow the animals to rest and move without hurting themselves.

In particular, certain structures of these livestock farms must be protected to prevent the animals from hurting themselves when moving or rubbing.

It is indeed common for animals to bump into and/or scratch themselves on structures that are not designed/adapted for that purpose, with the risks of skin lesions that ensue therefrom.

### SUMMARY OF THE INVENTION

In order to remedy the above-mentioned drawback of the state of the art, the present invention proposes an accessory for livestock farm, in particular cattle, horses or pigs, intended to be fastened to a structure to be covered and protected.

More particularly, the invention relates to an accessory consisting of a plate made of an elastic material, advantageously an elastomeric elastic material, preferably obtained by moulding, said accessory including:
at least one central strip having a front face and a rear face, said front face being provided with several protruding elements adapted for animal brushing, and
at least two lateral and/or transverse strips, adapted to receive means for their securing to said structure.

Such an accessory hence has the following advantages:
it can be fastened on any structure of the livestock enclosure, for example a corner post, a feeder or a fence,
it prevents impact injuries in the corners of building structure columns (IPN, concrete wall, etc.),
it ensures a protection of the covered structure,
it allows the animal to efficiently scratch itself, without risk of injury.

Other non-limitative and advantageous features of the product according to the invention, taken individually or according to all the technically possible combinations, are the following:
the rear face of said at least one central strip includes at least one longitudinal groove, advantageously generally cylindrical or dihedral in shape;
the thickness of said at least one central strip is greater than the thickness of said at least two lateral strips, with advantageously said at least one central strip having a thickness of 10 to 30 mm and said at least two lateral strips having a thickness of 5 to 15 mm;
the protruding elements consist of studs, advantageously pyramidal or conical in shape;
the protruding elements have the following dimensions: a height of 5 to 30 mm, preferably 10 to 20 mm, and a base width of 10 to 20 mm;
the centre distance between the protruding elements is from 15 to 50 mm;
the protruding elements are made integral with or added to the front face of said at least one central strip;
said at least two lateral strips each have a front face and a rear face; at rest, the rear faces of the lateral strips are coplanar; and the front face of said at least two lateral strips includes a longitudinal groove for participating to the locking of the securing means;
the front face of said at least one central strip has a convex curved cross-section over which are distributed the protruding elements;
said plate has a rectangular or square contour; in this case, said plate advantageously has the following dimensions: a length of 1 m to 2 m, and a width of 15 cm to 50 cm;
said at least one central strip has a width from 10 cm to 40 cm, and said at least two lateral strips each have a width from 3 to 10 cm;
the accessory includes at least one reinforcement sub-layer that extends at least in the thickness of said lateral strips;
the protruding elements are distributed over the whole length (or at least approximately the whole length) of the front face, or over part of the length of the front face;
at least two protruding elements are connected by a rib that is made integral with the front face of said at least one central strip and with the associated protruding elements; preferably, the ribs extend parallel to each other, preferably parallel to two lateral borders or to two transverse borders; still preferably, the protruding elements are distributed over the front face with a regular pattern, along parallel lines, and the protruding elements of one line are connected by a rib that is made integral with the front face of said at least one central strip and with the associated protruding elements.

The present invention also relates to a livestock enclosure, a structure of which is covered with an accessory according to the invention.

Preferably, said accessory is secured to the structure by positioning of securing means at said at least two lateral strips.

Of course, the different features, alternatives and embodiments of the invention can be associated with each other according to various combinations, insofar as they are not incompatible with each other or exclusive from each other.

### BRIEF DESCRIPTION OF THE DRAWINGS

Moreover, various other features of the invention will be apparent from the appended description made with reference to the drawings that illustrate non-limitative embodiments of the invention, and wherein:

FIG. 1 is a cross-sectional view of an accessory according to the invention;

FIG. 2 is a top view of an embodiment of the accessory according to FIG. 1, wherein the protruding elements are distributed over part of the length of a central strip;

FIG. 3 is a cross-sectional view of the accessory according to the invention, added on a structure of the enclosure to be covered and protected;

FIG. 4 is a general and perspective view of a second embodiment of the accessory according to the invention;

FIG. 5 is a partial and enlarged view of the accessory according to the second embodiment illustrated in FIG. 4.

It is to be noted that, in these figures, the structural and/or functional elements common to the different variants can have the same references.

### DESCRIPTION OF THE PREFERRED EMBODIMENTS

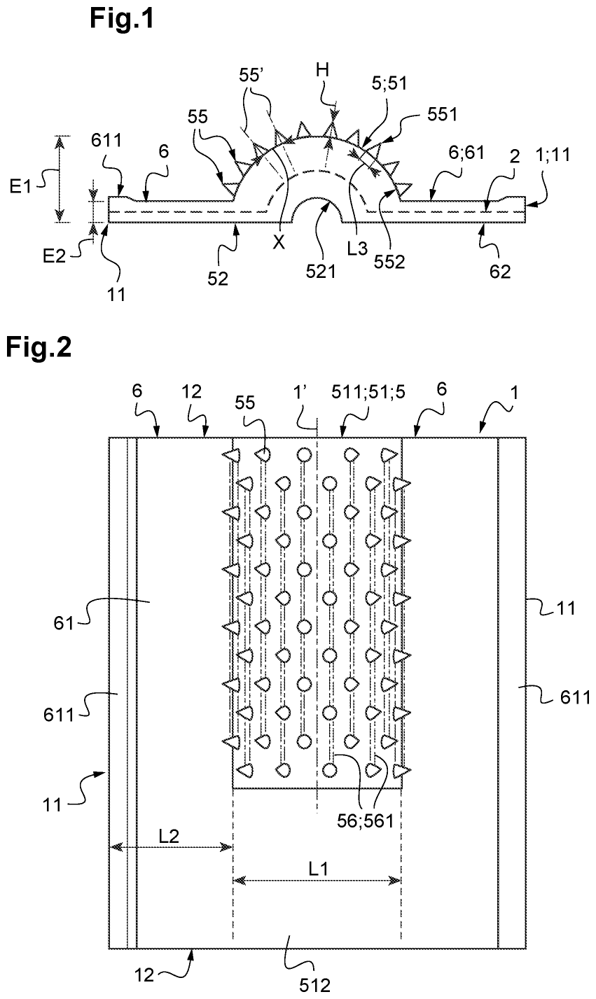

The present accessory 1, as illustrated in FIGS. 1 to 5, consists of a product designed for livestock farming, in particular cattle, horses or pigs.

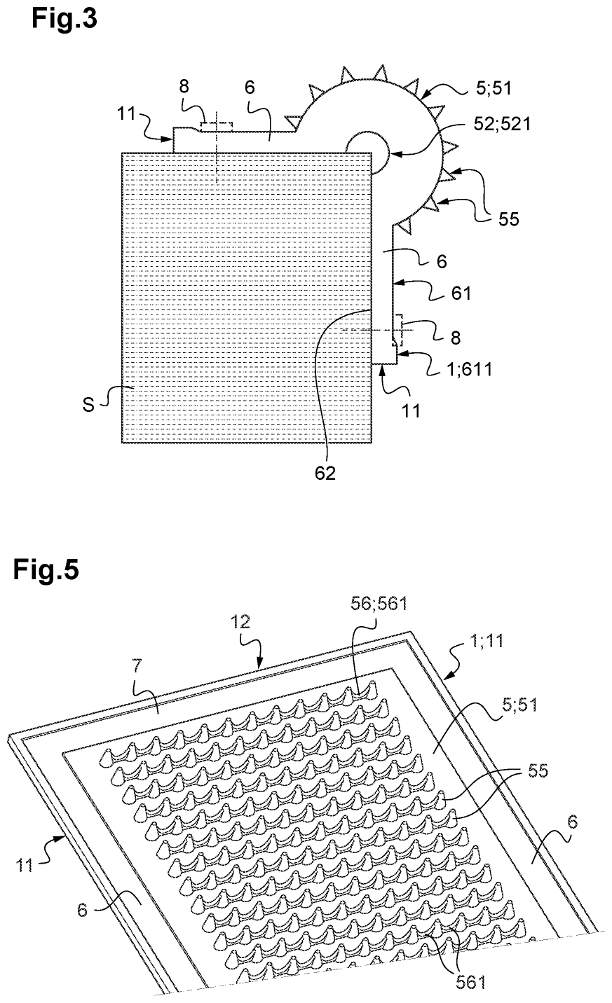

As developed hereinafter with FIG. 3, this accessory 1 is intended to be fastened to a structure S of a livestock farm, generally a protruding structure, to be covered and protected to avoid animal injuries.

For that purpose, the accessory 1 consists of a plate made of an elastic material, advantageously an elastomeric elastic material.

By “elastic material”, it is meant in particular a material able to undergo an elastic deformation, advantageously chosen among:
the elastomeric materials, i.e. for example the natural rubber, the “synthetic natural” rubber (or synthetic poly-isoprene), the polybutadiene or the styrene-budatiene, or
the plastic or thermoplastic elastomeric (TPE) materials, i.e. for example PVB (polyvinyl butyral), ABS (acrylonitrile butadiene styrene)/SBR (styrene-butadiene), PP (polypropylene)/EPDM (ethylene-propylene-diene monomer), TPU (TPE polyurethane).

This accessory 1 is advantageously one-piece made, either single-material (made of only one material), or multi-material (with at least two superposed sub-layers made in different materials).

This accessory 1 can also contain at least one reinforcement sub-layer 2, chosen among textile fibres, metal fibres, or any other product providing stability and/or resistance to elongation.

This reinforcement sub-layer 2 consists for example of a textile insert serving as a reinforcement, advantageously made of a material chosen among nylon, cotton, polyester, polyamide or any other reinforcement textile.

Such an accessory 1 is preferably obtained by a moulding technique.

Preferably, the plate forming the accessory 1 has a rectangular or square contour, here delimited by two lateral borders 11 (long sides) and by two transverse borders 12 (short sides) (FIG. 2).

This plate also includes a longitudinal axis 1′, directed parallel to the lateral borders 11.

This accessory 1 advantageously has the following dimensions:
a length of 1 m to 2 m (according to a dimension measured between the transverse borders 12), and
a width of 15 cm to 50 cm (according to a dimension measured between the lateral borders 11).

Moreover, according to the invention, this accessory 1 includes several strips 5, 6 that are juxtaposed laterally and that are advantageously directed parallel to the lateral borders 11.

Hence, the longitudinal axis of a strip 5, 6 advantageously extends parallel to the lateral borders 11.

Herein, this accessory 1 includes the following strips:
at least one central strip 5 provided with several protruding elements 55 that are adapted for animal brushing/scratching by rubbing, and
at least two lateral strips 6 each adapted to receive means 8 for their securing to each other and/or to the above-mentioned structure S (FIG. 3).

In other words, said at least one central strip 5 is arranged between the two lateral strips 6. Advantageously, each lateral strip 6 itself forms one of the lateral borders 11.

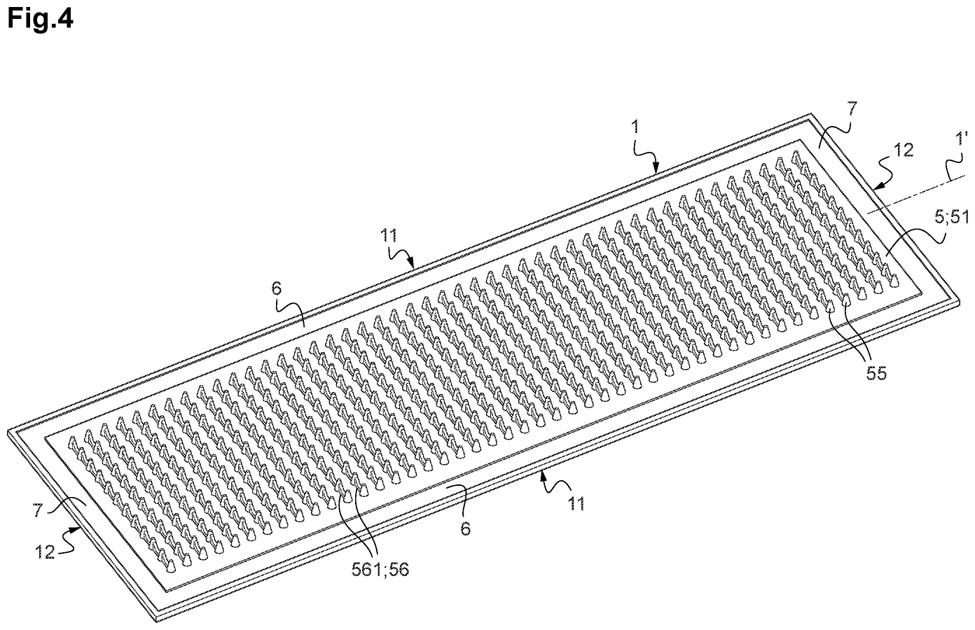

The accessory 1 may include transverse strips 7, similar to the lateral strips 6, each adapted to receive means 8 for their securing to each other and/or to the above-mentioned structure S (FIGS. 4 and 5).

As the case may be, each transverse strip 7 itself advantageously forms one of the transverse borders 12.

Preferably, said at least one central strip 5 has a width L1 from 10 cm to 40 cm; said at least two lateral strips 6 (and, as the case may be, said at least two transverse strips 7) each have a width L2 from 3 to 10 cm.

Said at least one central strip 5 includes two opposite faces 51, 52 defining the thickness E1 thereof, i.e.:
a front face 51, intended to come opposite the structure S and provided with protruding elements 55 adapted for animal brushing, and
a rear face 52, intended to come against an outer face of the structure S.

The front face 51 of said at least one central strip 5 can have a convex curved cross-section over which are distributed the protruding elements 55 (FIGS. 1 to 3).

This front face 51 of said at least one central strip 5 can also have a flat cross-section over which are distributed the protruding elements 55 (FIGS. 4 and 5).

The protruding elements 55 advantageously consist of studs (also called “nipples” or “lugs”), also made of the above-mentioned elastic material (elastomeric materials, or plastic or thermoplastic elastomeric (TPE) materials).

These protruding elements 55 have a shape that is adapted for animal scratching while preventing rubbing injuries, i.e. for example a pyramidal shape or a conical shape.

These protruding elements 55 can be:
integral with the front face 51 of said at least one central strip 5, or
added to the front face 51 of said at least one central strip 5.

The “integral” protruding elements 55 are also made by moulding, during the manufacturing of the accessory 1.

The “added” protruding elements 55 are secured to the front face 51 through suitable fastening means (not shown), i.e. for example a bolt and a notch to be screwed, moulded in the mass.

The protruding elements 55 have for example the following dimensions:
a height H of 5 to 30 mm, preferably of 10 to 20 mm, and
a base width L3 of 10 to 20 mm.

The height H corresponds to the axial distance between the front face 51 and the free end 551 of the protruding element 55. The base width L3 corresponds to a dimension (diameter, side, for example) of the base 552 of the protruding element 55 secured to the front face 51.

The protruding element 55 are distributed over the front face 51, advantageously according to a regular pattern, for example a staggered pattern or parallel lines (FIGS. 2, 4 and 5).

The protruding elements 55 (preferably along a straight line) can be connected by at least one rib 56 that is made integral with the front face 51 of said at least one central strip 5 and with the associated protruding elements 55 (these ribs 56 are very schematically shown in FIG. 2).

These ribs 56 are intended to reinforce the protruding elements 55 against mechanical stresses applied by the animals. Such ribs 56 are also interesting to avoid a degradation by bites, in particular among pigs.

The protruding elements 55 are here distributed over the length of each rib 56 (advantageously rectilinear). Each rib 56 is then composed of rib sections 561 that each connect two juxtaposed protruding elements 55.

Each rib section 561 hence forms a reinforcement between two juxtaposed protruding elements 55.

Each rib section 561 here has, without being limitative, a free border of concave curved shape (see in particular FIG. 5).

The ribs 56 advantageously extend parallel to each other.

These ribs 56 further advantageously extend parallel:
to the two lateral borders 11 (long sides), preferably for the accessory 1 to be positioned with its longitudinal axis 1′ directed vertically, or
to the two transverse borders 12 (short sides), preferably for the accessory 1 to be positioned with its longitudinal axis 1′ directed horizontally.

In practice, the ribs 56 are advantageously directed vertically to favour the fall of matters (hair, soil, etc.) by gravity (and hence avoiding a potential accumulation of matter on these ribs 56).

Each rib 56 advantageously has height and width that are lower than the dimensions of the associated protruding elements 55.

Moreover, the distribution of the protruding elements 55 can for example exhibit two alternatives over the length of the front face 51:
the protruding elements 55 are distributed over the whole length (or at least approximately the whole length) of the front face 51, between the two transverse borders 12 (in particular FIG. 4), or
the protruding elements 55 are distributed over part of the length of the front face 51.

In the second alternative, as illustrated in FIG. 2, the front face 51 hence has two areas:
an upper area 511 including the protruding elements 55, adapted for animal rubbing, and
a lower area 512 devoid of protruding elements 55, advantageously of length between 0.5 and 1.5 m, to prevent animals from injuring their legs when rubbing on the upper area 511.

Each protruding elements 55 also has a longitudinal axis 55′. The linear distance between two longitudinal axes 55′ (along a line on the front face 51) defines a centre distance X.

And the centre distance X between the juxtaposed protruding elements 55 is advantageously from 15 to 50 mm.

Moreover, the rear face 52 of said at least one central strip 5 includes at least one longitudinal groove 521, advantageously generally cylindrical in shape (or even, as an alternative, dihedral in shape, also called V-shaped cross-section).

The longitudinal axis of said at least one longitudinal groove 521 extends parallel to the lateral borders 11.

This longitudinal groove 521 helps to reduce the resistance to deformation of the accessory 1, advantageously during a folding consisting in moving the lateral strips 6 closer to each other.

Each lateral strip 6 has also two opposite faces 61, 62 defining the thickness E2 thereof, i.e.:
a front face 61, intended to come opposite the structure S, and
a rear face 62, intended to come against an outer face of the structure S.

At least one reinforcement sub-layer 2 extends at least in the thickness of the lateral strips 6 and, as the case may be, the transverse strips 7 (or even also in the thickness of said at least one central strip 5).

At rest (before the mounting of the structure S), the rear faces 62 of the lateral strips 6 (or, in other words, the general planes of the two lateral strips 6) are advantageously coplanar (in particular to facilitate the transportation and storage). The accessory 1 then consists of a flat plate, particularly adapted for the flat transportation and storage (FIGS. 4 and 5, for example).

As an alternative, at rest (before the mounting on the structure S), the rear faces 62 of the lateral strips 6 (or, in other words, the general planes of the two lateral strips 6) can define together an angle lower than 180°, for example of the order of 90°, as illustrated in FIG. 3. The accessory 1 then consists of an angle plate (also called dihedral, or even L-shaped plate), whose ridge extends along the central strip 5.

The front face 61 of the lateral strips 6 (and, as the case may be, of the transverse strips 7) herein includes a longitudinal rib 611, advantageously lining its lateral border 11 (and, as the case may be, its transverse border 12), for participating to the locking of the securing means 8 and optimizing the resistance to the mechanical efforts.

Moreover, the thickness E1 (maximum) of said at least one central strip 5 is advantageously greater than the thickness E2 of said at least two lateral strips 6 (and, as the case may be, greater than the thickness of said at least two transverse strips 7).

For example, said at least one central strip 5 has a thickness E1 of 10 to 30 mm, and said at least two lateral strips 6 (or even the transverse strips 7) have a thickness E2 of 5 to 15 mm.

Livestock Enclosure

FIG. 3 shows a structure S, advantageously present within a livestock enclosure (not shown), which is covered with an accessory 1 as described hereinabove in relation with FIGS. 1 and 2.

The structure S, generally a protruding structure, can be any structure of the livestock enclosure, for example a corner post, a feeder or a fence.

The accessory 1 is secured to the structure S by positioning of securing means 8 at the lateral strips 6 (or even also at the transverse strips 7), advantageously along the longitudinal ribs 611.

For example, these securing means 8 comprise:
at least one profile added on the front face 61 of the lateral strip 6 (or even of the transverse strips 7), and
fastening parts introduced through the lateral strip 6 (or even the transverse strips 7), to penetrate, as the case may be through the reinforcement sub-layer 2, into the structure S.

The accessory 1 is adapted to be deformed in such a way as to conform at best the structure S, in particular thanks to its material and its longitudinal groove 521.

Moreover, the accessory 1 may be positioned, for example, with its longitudinal axis 1′ directed horizontally or vertically.

Preferably, the accessory 1 according to FIGS. 1 to 3 is positioned with its longitudinal axis 1′ directed vertically; the accessory 1 according to FIGS. 4 and 5 is positioned with its longitudinal axis 1′ directed horizontally.

In the case of a front face 51 including two areas 511, 512, the accessory 1 is advantageously directed vertically, with the upper area 511 upward and the lower area 512 downward.

In practice, the structure S is then covered and protected by the accessory 1, in such a way as to avoid the skin lesions of the animals.

The animals can further come and rub against the accessory 1, and hence scratch on the protruding elements 55 carried by said at least one central strip 5.

Of course, various other modifications may be made to the invention within the framework of the appended claims.

1. An accessory for livestock farm, in particular cattle, horses or pigs, intended to be fastened to a structure to be covered and protected,
wherein said accessory consists of a plate made of an elastic material,
said accessory including:
at least one central strip having a front face and a rear face, said front face being provided with several protruding elements adapted for animal brushing, and
at least two lateral and/or transverse strips, adapted to receive means for their securing to said structure.

2. The accessory for livestock farm, according to claim 1, wherein the rear face of said at least one central strip includes at least one longitudinal groove, advantageously generally cylindrical or dihedral in shape.

3. The accessory for livestock farm, according to claim 1, wherein the thickness of said at least one central strip is greater than the thickness of said at least two lateral strips.

4. The accessory for livestock farm, according to claim 1, wherein the protruding elements consist in studs.

5. The accessory for livestock farm, according to claim 1, wherein the protruding elements have the following dimensions:
a height of 5 to 30 mm,
a base width of 10 to 20 mm.

6. The accessory for livestock farm, according to claim 1, wherein the protruding elements are made integral with or added to the front face of said at least one central strip.

7. The accessory for livestock farm, according to claim 1, wherein said plate have a rectangular or square contour.

8. The accessory for livestock farm, according to claim 7, wherein said plate has the following dimensions:
a length of 1 m to 2 m, and
a width of 15 cm to 50 cm.

9. The accessory for livestock farm, according to claim 1, wherein:
said at least one central strip has a width from 10 cm to 40 cm, and
said at least two lateral strips each have a width from 3 to 10 cm.

10. The accessory for livestock farm, according to that it includes claim 1, further comprising at least one reinforcement sub-layer that extends at least in the thickness of said lateral strips.

11. The accessory for livestock farm, according to claim 1, wherein the protruding elements are distributed:
over the whole length, or at least approximately the whole length, of the front face, or
over part of the length of the front face.

12. The accessory for livestock farm, according to claim 1, wherein at least two protruding elements are connected by a rib that is made integral with the front face of said at least one central strip and with the associated protruding elements.

13. The accessory for livestock farm, according to claim 12, wherein the ribs extend parallel to each other.

14. A livestock enclosure, a structure of which is covered with an accessory according to claim 1.

15. The accessory for livestock farm of claim 1, wherein the elastic material elastomeric.

16. The accessory for livestock farm of claim 15, wherein the plate is produced by moulding.

17. The accessory for livestock farm of claim 4, wherein the studs are pyramidal or conical in shape.

18. The accessory for livestock farm of claim 5, wherein the height of the protruding element is in a range of 10 to 20 mm.

19. The accessory for livestock farm of claim 5, wherein the ribs are parallel to two lateral borders or to two transverse borders.

20. The accessory for livestock farm, according to claim 2, wherein the thickness of said at least one central strip is greater than the thickness of said at least two lateral strips.
